(19) United States
(12) Patent Application Publication
(10) Pub. No.: US 2025/0069840 A1
(43) Pub. Date: Feb. 27, 2025

(54) DISTRIBUTION SYSTEM PROTECTION DEVICE WITH RFID READER FOR VARIABLE CURRENT SETTING

(71) Applicant: Hubbell Incorporated, Shelton, CT (US)

(72) Inventors: David Adelbert Rhein, Birmingham, AL (US); Chandiran Sundarraj, Tamilnadu (IN)

(21) Appl. No.: 18/812,330

(22) Filed: Aug. 22, 2024

Related U.S. Application Data
(60) Provisional application No. 63/578,283, filed on Aug. 23, 2023.

(51) Int. Cl. H01H 85/32; H01H 75/00; H01H 85/02; H01H 85/46

(52) U.S. Cl. CPC H01H 85/32; H01H 75/00; H01H 85/0241; H01H 85/46; H01H 2300/032

(57) ABSTRACT

A recloser for a distribution system includes a current sensor configured to measure an operating current of a distribution system. A controller is connected to the current sensor. The controller has at least one processor. A circuit interrupter is connected to the controller and configured to open a circuit to interrupt power in at least a portion of the distribution system. An RFID reader connected to the controller, the RFID reader configured to receive data from a user. The controller is configured to trigger the circuit interrupter to open the circuit in response to a detected fault current. The fault current is determined based on a selected fuse curve.

### RELATED APPLICATION(S)

This application is based on U.S. Provisional Application Ser. No. 63/578,283, filed Aug. 23, 2023, the disclosure of which is incorporated herein by reference in its entirety and to which priority is claimed.

### FIELD

Various implementations relate to fuse devices for power distribution systems.

### BACKGROUND

Circuit interrupting devices, such as circuit breakers, sectionalizers, cutouts, and reclosers provide protection for power distribution systems and the various apparatus on those power distribution systems such as transformers and capacitor banks by isolating a faulted section from the main part of the system. A fault current in the system can occur under various conditions, including but not limited to lightning, an animal or tree shorting the power lines, or different power lines contacting each other. Conventional circuit interrupting devices sense a fault and interrupt the current path. Conventional reclosers also re-close the current path and monitor continued fault conditions, thereby re-energizing the utility line upon termination of the fault. This provides maximum continuity of electrical service. If a fault is permanent, the recloser remains open after a certain number of reclosing operations that can be pre-set.

A fuse cutout is a combination of a fuse and a switch that is actuated by an overcurrent event. An overcurrent caused by a fault in the transformer or customer circuit will cause the fuse to melt, disconnecting the transformer from the line. To facilitate disconnection, cutouts are typically mounted about 20 degrees off vertical so that the center of gravity of the fuse holder is displaced and the fuse holder will rotate and fall open under its own weight when the fuse blows. Mechanical tension on the fuse link normally holds an ejector spring in a stable position. When the fuse blows, the released spring pulls the stub of the fuse link out of the fuse holder tube to reduce surge duration and damage to the transformer and fuse holder to quench any arc in the fuse holder. The cutout can also be opened manually by utility linemen standing on the ground and using a long insulating stick called a “hot stick”.

A cutout can include three major components. The first component is the cutout insulator body, a generally open C-shaped frame that includes a conductive top hood piece and a conductive bottom hinge pieces which cooperate to accept a fuse holder as well as a ribbed porcelain or polymer insulator main portion that electrically isolates the conductive portions from the support bracket to which the insulator is fastened via a centrally extending mounting flange.

The second component is the fuse holder itself, also called the “fuse tube”, that is an insulating tube which contains the replaceable fuse element. When the fuse element operates (“melts”), the fuse holder subsequently drops out of the upper contact of the top hood of the insulator body, breaking the circuit, and hangs from a hinge on its lower end that cooperates with the bottom hinge of the insulator body via a pinion. The hanging fuse holder provides a visible indication that the fuse has operated and assurance that the circuit is open. The circuit can also be opened manually by pulling out the fuse holder using a hot stick with approved load break device.

The third component is the fuse element, or “fuse link”, which is the replaceable portion of the cutout assembly that operates when the electrical current is great enough. In operation, after the fuse link has blown and the fuse holder drops, a lineman replaces the fuse link and re-deploys the fuse tube in its operating condition between the conductive top hood and bottom hinge pieces of the fuse cutout insulator body. The fuse holder can be equipped with a pull ring that can be engaged by a hook at the end of the fiberglass hot stick operated by a lineworker standing on the ground or from a bucket truck, to manually close/open the switch.

If equipped with appropriate mechanisms, cutouts can act as sectionalizers, used on each distribution line downstream from autoreclosing circuit breakers. Autoreclosers sense and briefly interrupt fault currents, and then automatically reclose to restore service. Meanwhile, downstream sectionalizers automatically count current interruptions by the recloser. When a sectionalizer detects a preset number of interruptions of fault current (typically 2, 3, or 4) the sectionalizer opens (while unenergized) and remains open, and the recloser restores supply to the other non-fault sections.

Fuse cutouts can also be utilized as a dropout recloser. A dropout recloser can determine the number of fault current interruptions and drop from a cutout once the set number of faults is reached. A dropout recloser can therefore include reclosing components and fault interrupting components. These components can include the dropout mechanism of a standard fuse cutout, along with a controller housed, for example, with the fuse tube, and configured to determine an overcurrent condition, count the overcurrent cycles over a given time, and activate the dropout mechanism as needed.

### SUMMARY

In certain configurations, a fuse device for a distribution system includes a variable current setting.

In certain configurations, a fuse device for a distribution system includes a variable current setting configurable via an RFID device.

In certain configurations, a fuse device for a distribution system includes a variable current setting configurable via an RFID device that includes an RFID tag connected to a hot stick.

In certain configurations, a fuse device for a distribution system includes a variable current setting configurable via an RFID device that includes an RFID tag connected to a hot stick and positioned by a user from the ground.

In certain configurations, a recloser for a distribution system includes a current sensor configured to measure an operating current of a distribution system. A controller is connected to the current sensor. The controller has at least one processor. A circuit interrupter is connected to the controller and configured to open a circuit to interrupt power in at least a portion of the distribution system. An RFID reader connected to the controller, the RFID reader configured to receive data from a user. The controller is configured to trigger the circuit interrupter to open the circuit in response to a detected fault current. The fault current is determined based on a selected fuse curve.

In certain configurations, a distribution system fuse includes an insulator body having a weathershed. A support bracket extends from the insulator body. A hood is connected to the insulator body. The hood has a hood contact. A hinge member extends from the insulator body. A recloser is pivotally connected to the insulator body by engagement of a pivot with the hinge member. The recloser has a current sensor configured to measure an operating current of a distribution system. A controller is connected to the current sensor, the controller having at least one processor. A circuit interrupter is connected to the controller and configured to open a circuit to interrupt power in at least a portion of the distribution system. An RFID reader is connected to the controller. The RFID reader is configured to receive data from a user. The controller is configured to trigger the circuit interrupter to open the circuit in response to a detected fault current and the fault current is determined based on a selected fuse curve.

Certain implementations are directed to a method of setting the operating parameters of a controller for a distribution system fuse device. A signal is emitted from a first RFID device. The emitted signal is received at a second RFID device. A response is emitted from the second RFID device, the response containing fuse curve data. The fuse curve data is extracted. The operating parameters of a controller are adjusted based on the fuse curve data.

Certain implementations are directed to a method of setting the operating parameters of a controller for a distribution system fuse device. A signal is emitted from a first RFID device. The signal contains fuse curve data. The emitted signal is received at a second RFID device. The fuse curve data is extracted. The operating parameters of a controller are adjusted based on the fuse curve data.

### BRIEF DESCRIPTION OF THE DRAWINGS

The aspects and features of various exemplary embodiments will be more apparent from the description of those exemplary embodiments taken with reference to the accompanying drawings.

FIG. 1 is a side perspective view of a dropout recloser.

FIG. 2 is a partial view of the hinge and pivot of the dropout recloser of FIG. 1.

FIG. 3 is a schematic view of the recloser internal components.

FIG. 4 is a chart showing a set of type K fuse curves.

FIG. 5 is a chart showing a set of type T fuse curves.

FIG. 6 is a chart showing a set of type MS fuse curves.

FIG. 7 is a chart showing a set of type STH fuse curves.

FIG. 8 is a chart showing a set of type QH fuse curves.

FIG. 9 is a chart showing a set of type SLOFAST fuse curves.

FIG. 10 is a schematic view of the recloser internal components using and RFID system.

FIG. 11 is a flow chart of a method of adjusting the operating parameters of the controller based on a received RFID signal for a passive RFID tag.

FIG. 12 is a flow chart of a method of adjusting the operating parameters of the controller based on a received RFID signal for an active RFID tag.

### DETAILED DESCRIPTION OF EXEMPLARY EMBODIMENTS

Certain implementations are directed to a fuse device used in a power distribution system. The fuse device can be connected to an overhead power line system, for example being connected to a utility pole, either directly or through one or more mounting brackets. The fuse device can be configured to disconnect from the power distribution system when a certain condition occurs, for example one or more overcurrent fault conditions. The fuse device can be reconnected to the power distribution system by a lineman or other technician.

In certain operations, the lineman will engage the fuse device with a hot stick. Hot sticks typically include a pole made from an insulated material such as fiberglass. Hot sticks can have different lengths, ranging from about 6 feet to about 40 feet, and can be telescopic to provide for an adjustable length. This allows lineman to stay a sufficient distance from potentially live voltage components. The end of a hot stick can be equipped with different components on the far end to perform different operations. For example, moveable or stationary hooks can be provided on the far end of the hot stick to allow a lineman to manipulate components at a distance. The lineman can position the hot stick from the ground or from an elevated position, such as in a bucket truck.

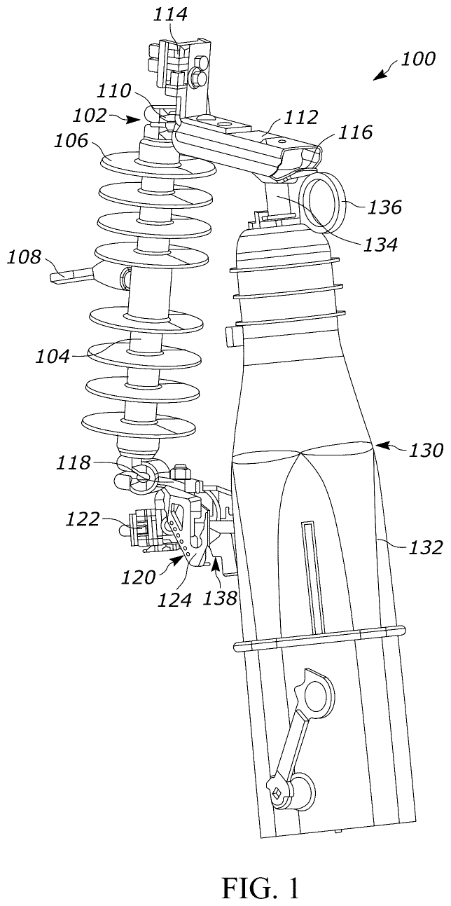

FIG. 1 shows an exemplary circuit interrupting device 100 having a cutout insulator 102. As depicted, the cutout insulator 102 includes an insulator body 104 having a plurality of watersheds 106. The insulator body 104 can be made from a suitable dielectric material. For example, the insulator can include thermal plastic, such as high-density polyethylene (HDPE) or PPE resin. Certain configurations can include thermal set material, such as epoxy or vinyl ester. The insulator body 104 can be molded, for example, injection molded, and the molding can include reinforcing fillers to enhance properties of the insulator body 104, such as, but not limited to, hydrophobic properties, UV stability, and track resistance.

A support bracket 108 extends from the insulator body 104. The support bracket 108 can be connected to a central region of the insulator body 104 and can include an opening to receive a mounting fastener. The support bracket 108 can connect the insulator body 104 to a support, such as a utility pole or crossarm, either directly or connected through one or more mounting brackets. The support bracket 108 or other mounting structure can be configured to mount the insulator body 104 at an angle so that a longitudinal axis of the insulator 102 extends at an oblique angle relative to a vertical axis as determined relative to the ground.

An upper bracket 110 extends from an upper portion of the insulator body 104. The upper bracket 110 can be connected to a hood 112 having a proximal portion and a distal portion. The proximate portion can include an upper terminal 114 that is configured to receive a supply connection. The distal portion can include a hood contact 116 extending from the hood 112. The hood contact 116 can be biased away from the hood 112 by, for example, a spring.

A lower bracket 118 extends from a lower portion of the insulator body 104. The lower bracket 118 connects to a hinge member 120. The hinge member 120 has a lower terminal 122 that receives a load connection. The hinge member 120 also has a pivot connection. The pivot connection can include a pair of arms 124 having an outer hook defining a cradle. The support bracket 108, upper bracket 110, and lower bracket 118 can be electrically isolated form one another by the insulator body 104.

A recloser 130 is connected to the cutout insulator 102. The recloser 130 includes a recloser body 132. A recloser contact 134 extends from a first portion of the recloser body 132. The recloser contact 134 is configured to releasably engage the hood contact 116. The recloser contact 134 can be configured to extend into engagement with the hood contact 116 so that the hood contact 116 is biased against the spring. This engagement can provide a retaining force to hold the hood contact 116 and the recloser contact 134 in engagement.

An upper engagement interface can also extend from the first portion of the recloser body 132. The upper engagement interface provides a contact point for a user to manipulate the recloser 130. In certain configurations, the upper engagement interface is configured to interact with a hot stick. In certain configurations, the upper engagement interface can include a ring 136 that extends outwardly from the recloser body 132.

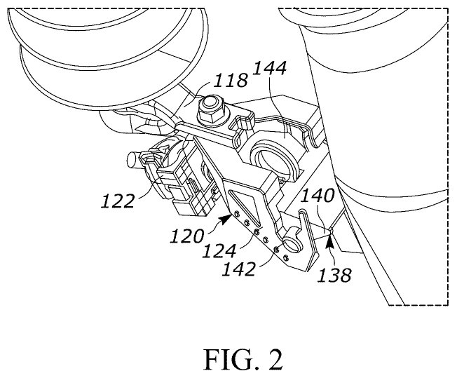

As best shown in FIG. 2, a pivot 138 extends from a second portion of the recloser body 132 spaced from the first portion along a vertical axis. The pivot 138 is positioned and configured to be received in the hinge member 120 of the insulator body 102. The pivot 138 can include a trunnion member 140 which is received in the cradle of the insulator body 102 hinge. The trunnion member 140 can include a pair of opposing projections 142 seated in the cradle to provide a rotatable connection between the recloser 130 and the cutout insulator 102.

A pivot engagement interface can extend from the pivot 138. The pivot engagement interface provides a contact point for a user to manipulate the recloser 130. In certain configurations, the pivot engagement interface is configured to interact with a hot stick. In an exemplary embodiment, the pivot engagement interface can include a second ring 144 that extends outwardly from the pivot 138. The second ring 144 can positioned at a different orientation from the first ring 136. The second ring 144 can be positioned on a different side of the recloser body 132 from the first ring 136. For example, the second ring 144 can be positioned on an opposite side of the recloser body 132 from the first ring 136. In configurations using a cylindrical body, the second ring 144 can be positioned at a different degree along the circumference of the cylindrical body. When other shapes are used, the second ring 144 can be positioned at a different angle relative to a longitudinal axis of the recloser body 132.

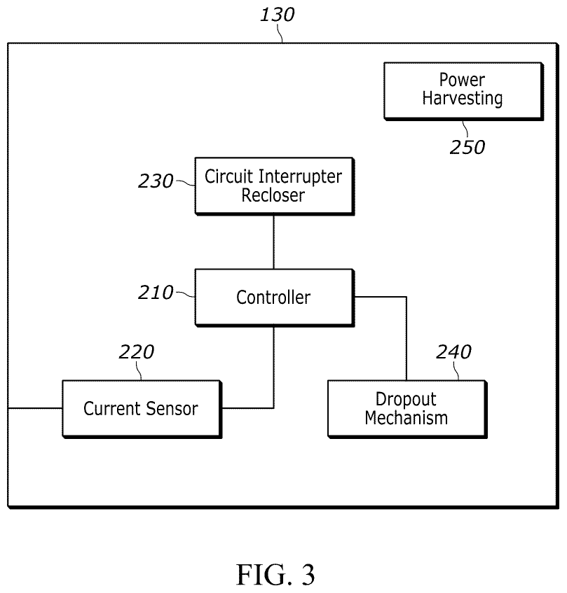

The recloser 130 can contain various internal components depending on the recloser's 130 operational requirements. FIG. 3 shows an exemplary schematic of a recloser 130 and an exemplary configuration of the internal components. These components will vary depending on if the circuit interrupting device 100 is being used as a cutout, sectionailzer, or a dropout recloser. In an example of a configuration as a dropout recloser, the recloser 130 can include a controller 210, a current sensor 220, a circuit interrupter/recloser 230, and a dropout mechanism 240. The circuit interrupter/recloser 230 can be a vacuum interrupter, although other types of interrupters may also be used. The circuit interrupter/recloser 230 can be activated by the controller to open when a fault is detected and to reclose after a certain amount of time. If the fault is not cleared after a certain amount of attempts, a dropout mechanism 240 can be activated to cause the recloser 130 to rotate in the hinge, separating the recloser contact 134 and the hood contact 116. The dropout mechanism 240 can include an actuator, for example a solenoid, that causes movement of the recloser 130 relative to the insulator 102.

The controller 210 can be configured to control the necessary functions and components of the recloser 130. The controller 210 can include one or more PCBs, microprocessors, microcontrollers, volatile and/or non-volatile memory, circuitry components (capacitors, transistors, etc.), and firmware that can be adjusted or updated by a user as necessary. One or more power harvesting components 250 can be included to provide power to various components. The power harvesting components 250 can include one or more power conversion devices (e.g., for converting AC power to DC power) and one or more power storage devices such as one or more capacitors or batteries. Any type of direct and indirect electrical connection can be used to supply power from the power harvesting components 250 to the other internal components. The types, number, and architecture of these components can be varied depending on the requirements of the recloser 130 as would be understood by one of ordinary skill in the art.

During an exemplary operation, the recloser 130 will initially be set so that the pivot 138 is seated in the hinge member 120 and the recloser contact 134 is engaged with the hood contact 116. If a fault condition is detected, the interrupter/recloser 230 can open for a set amount of time and then closed to see if the fault is cleared. If the fault is not cleared after a certain number of openings (e.g., two, three, or four), the dropout mechanism 240 is activated and the recloser 130 is pivoted so the recloser contact 134 is out of engagement with the hood contact 116, opening that portion of the distribution system. The recloser 130 pivots about the hinge member 120 so that the recloser body 132 is hanging in a downward orientation. A user, such as a lineman or other technician, will then need to go and reset the device by manually pivoting the recloser 130 back into engagement with the hood 112. The recloser 130 can also be removed from the hinge member 120 before being reset to or adjust components as needed.

In different applications, the controller and certain associated circuitry (e.g. solenoid, capacitors, etc.) will need to determine a fault condition based on different operating parameters of the system. In certain configurations, the controller and the associated circuitry will act as a fuse, operating on a fuse curve to determine the presence of a fault (e.g., excess current) and triggering an open/close cycle or dropout condition. For example, the current sensor 220 can provide data to the controller 210 on the operating current of the device, and the controller 210 can be configured to determine if a fault current is present and activate the circuit interrupter 230 as needed. In determining if the fault current is present, the controller 210 can compare the current over a period of time.

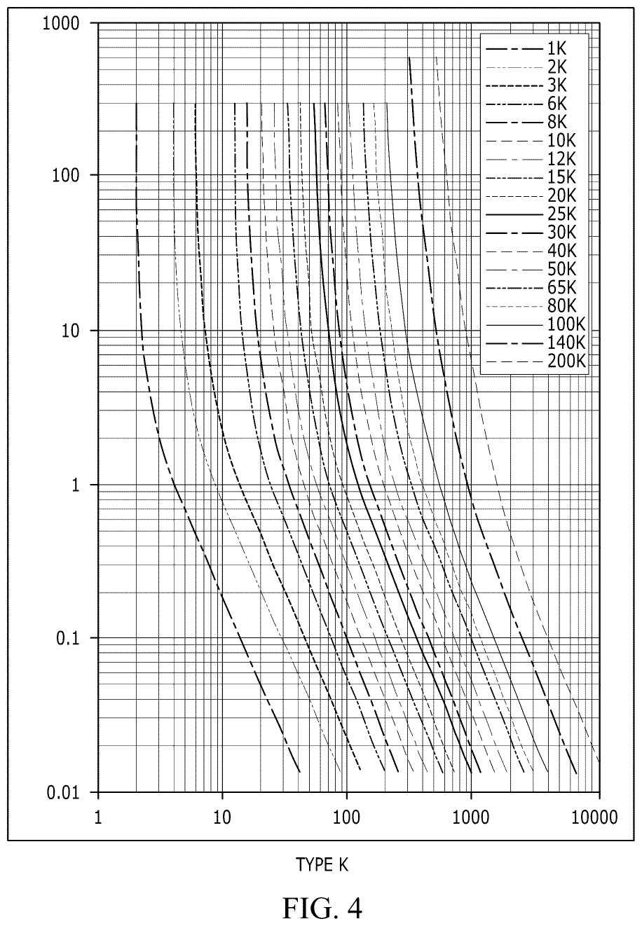

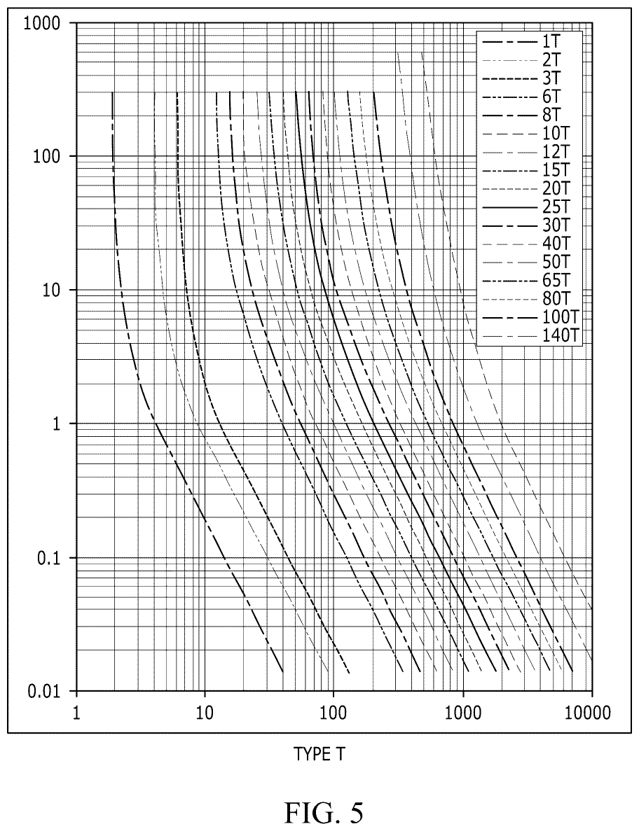

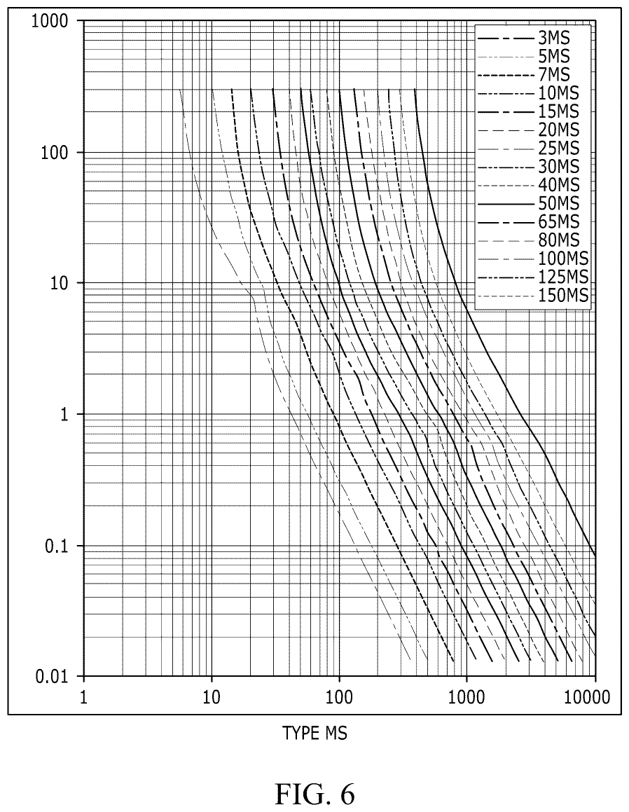

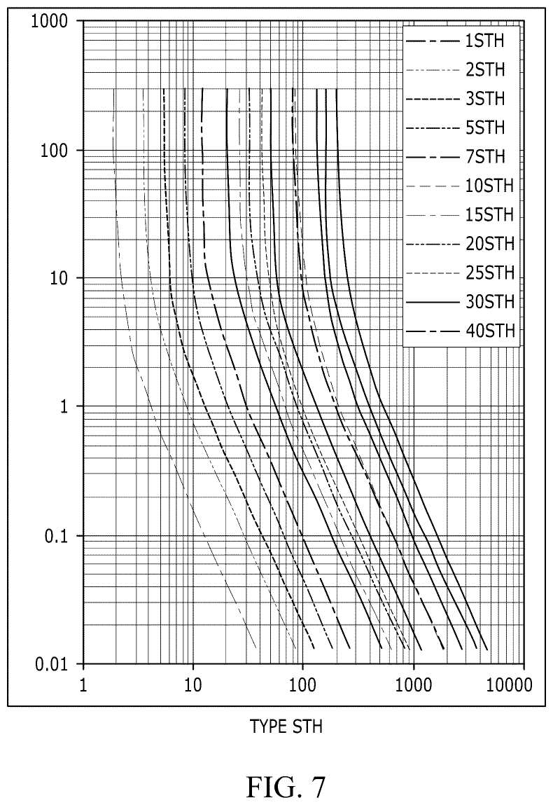

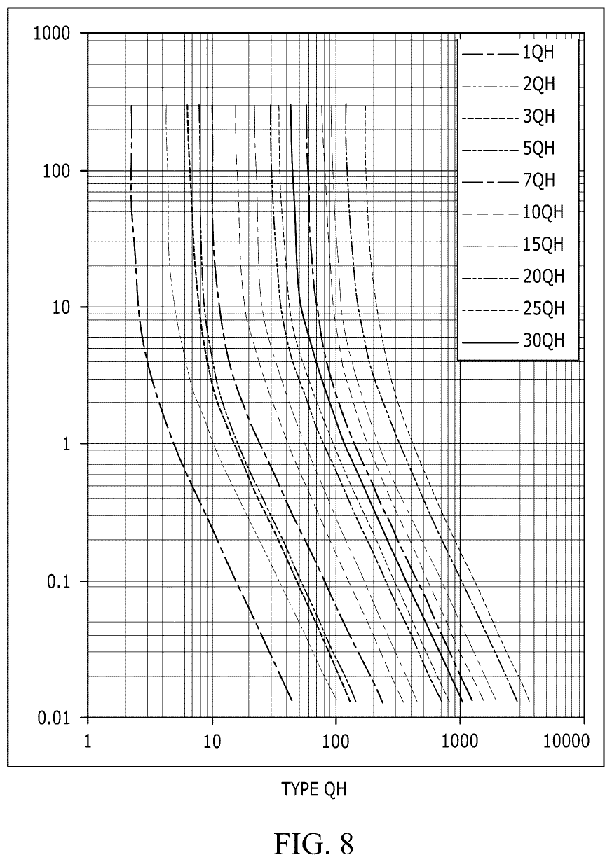

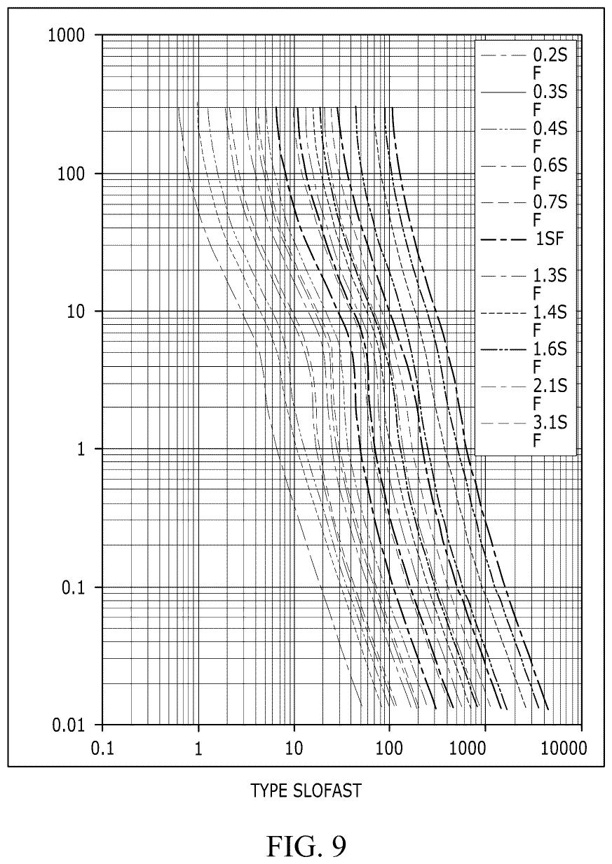

FIGS. 4-9 show exemplary fuse curve tables that can be simulated by the controller 210. Each chart shows a different type of curve (K, T, MS, STH, QH, SLOFAST) and each curve in the charts shows a different fuse amp rating for the type. The fuse curves show the time on the Y axis versus the current on the X axis. If a certain current over a set time as shown in the curves is reach than a fault condition can be triggered. These fuse curves (or the underlying data) can be saved in memory and the controller 210 can be configured to access and follow one or more of these curves as needed.

Typically, the fuse curve pattern for a device is set before the device is placed in the field. This can lead to many complications because protection products like a fuses or reclosers must have variable current protection trip or melt settings to be able to fit in a multitude of distribution circuit configuration and load levels. Also, coordination with other circuit protection devices already on the distribution circuit require multiple trip (melt) times or fuse curves. Factory preset has limitation in that utilities must inventory a multitude of SKUs for maintenance and replacement. Microcontroller based designs reduce the number of SKUs but require energy sources at the time of installation like batteries and communications devices with applications like phones or computers to complete the setting selection process.

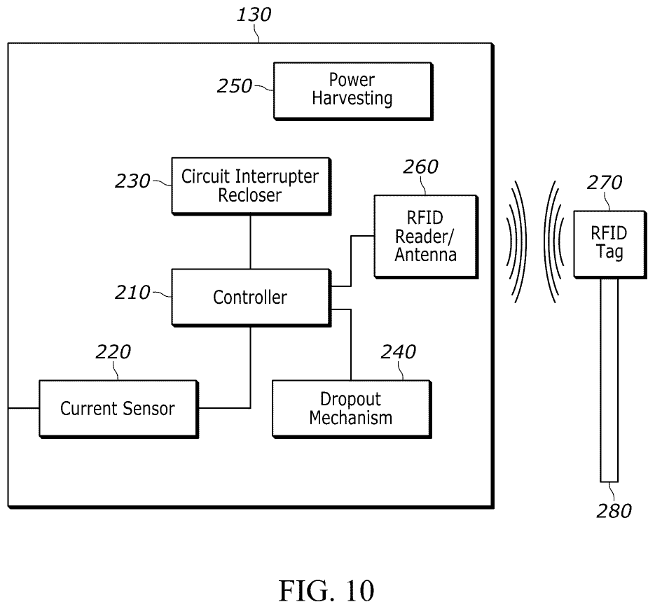

In various exemplary embodiments, the recloser 130 can include an RFID reader that allows a user to set the fuse curve on the recloser 130 and modify the fuse curve as needed. FIG. 10 shows an exemplary schematic of the recloser 130 that utilizes a RFID reader/antenna 260 in communication with the controller 210 to set and/or adjust the fuse curve type. The RFID read/antenna 260 can receive a signal from a user who positions an RFID tag 270 into communication with the RFID reader/antenna 260. In certain operations, the RFID tag 270 can be connected to a hot stick 280 and positioned in communication with the reader/antenna 260 after the recloser 103 is positioned in a distribution system. This can allow a user to change the fuse curve type of the recloser 130 after the recloser has been installed, eliminating the need to potentially change out the recloser entirely. The user can position the hot stick from the ground or from an elevated position, such as in a bucket truck.

The RFID system can operate at different frequency levels depending on the environment and application. The reader/antenna 260 and the tag 270 can be one or more devices or components as would be understood by one of ordinary skill in the art, and is shown as a single block for simplicity. The reader/antenna 260 is configured to receive information from the tag 270 and pass the information or instructions to the controller 210.

In certain configurations, the RFID tag 270 can be a passive tag that is activated by the reader/antenna 260. The reader/antenna 260 can emit a radio frequency signal which creates an electromagnetic field in the proximity of the tag 270. This activates the tag 270 by inducing an electrical current which briefly powers the tag's IC. Once powered, the tag's IC modulates the RF signal with its unique identification number and other stored data. This modulation alters the characteristics of the RF signal, encoding the tag's information into it. The modulated signal is then reflected back from the tag's antenna toward the reader 260.

The reader/antenna 260 receives the modulated RF signal from the passive tag 270 through its antenna. In some configurations, the reader/antenna 260 can include electronics that interpret the changes in the RF signal, extracting the encoded data from the tag 270 and transmitting it to the controller 210 which then operates according to the selected fuse curve. In some configurations, the controller is programmed to interpret the information transmitted by the tag 270 and associate the information with the proper fuse curve. The controller 210 can be configured to retrieve the requested operating parameters from a local memory or the operating parameter information can be transferred via the RF response signal emitted by the tag 270. In a passive tag system, the reader/antenna 260 can be configured to be continuously pinging for the tag 270 for information or can be set to operate at certain intervals.

In other embodiments, the RFID system can be configured where the tag 270 is active and the reader/antenna 260 is passive or both components are active. The tag 270 can include a power source which is either permanently on or activated by the user so that the reader/antenna 260 and controller 210 update only as needed.

In certain operations, the user, for example a lineman, can select a tag 270 that has the information containing a desired fuse curve type from a plurality of tags 270 (e.g., read only RFID tags). The tags 270 can include one or more markings (e.g., writing, symbols, etc.) that correspond to the fuse curve data present in the tag 270. Alternatively, the tag 270 can be programmed and reprogrammed by the user as desired to have the necessary fuse curve data (e.g., read/write RFID tags). The user can then position the tag 270 near the desired reader/antenna 260 to transfer the information to and reprogram the controller to operate using the desired fuse curve. In some operations, the user can attach the tag 270 to a hot stick 280 and position the tag 270 near the recloser 130, either from the ground or from an aerial position in a bucket truck. Other devices and ways of positioning the tag 270 relative to the recloser 130 may also be used. For example, a user may hold a tag while in an aerial position in a bucket truck, which may sufficient to transfer the information to the reader/antenna 260 depending on the distance the RFID signal can travel.

In some configurations, an indicator may be provided that communicates the receipt of the RFID signal and data transfer to the controller. For example, one or more visual indicators, such as LED indicators, can be positioned on the exterior of the recloser body 132. Audio signals or a wireless data signal sent to a user device, such as the tag 270, hot stick 280, or a smart phone or other portable electronic device.

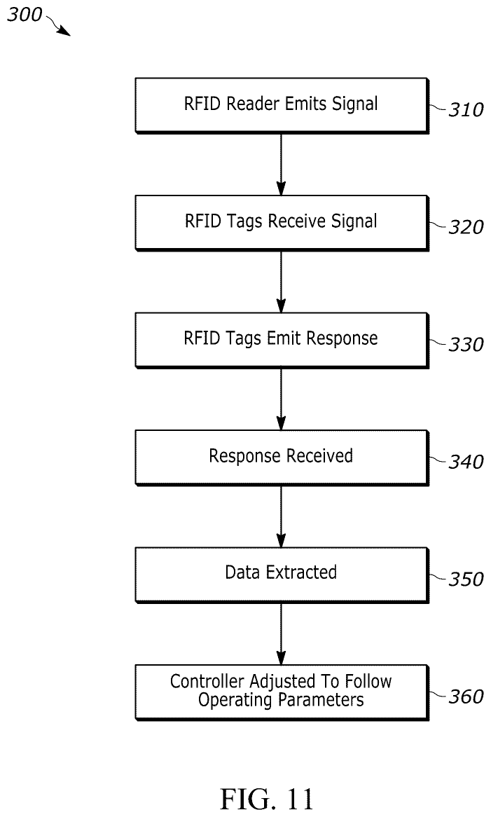

FIG. 11 shows an exemplary flow chart 300 for the controller 210 to select a fuse curve using a passive RFID tag. In a first step, an RFID reader emits an RF signal 310. The reader can be controlled by an external controller or through internal programming. One or more RFID tags receive the RF signal 320. The RFID tag(s) emits a response 330 which includes information (e.g., encoded data) programmed into the RFID tag relating to a selected fuse curve and/or fuse amp setting. The response is received by the reader 340 and the data is extracted 350. The data can be extracted by the reader or by the controller. The controller can then access and follow the selected operating parameters 360. For example, the controller will follow the selected fuse curve and/or amp rating selected by a user. The controller can receive the operating parameter information or associated data from a local memory, or the information can be provided by the RFID tag in the emitted response.

In certain forms, the controller may communicate with an external device (e.g., a computer) with a user interface. The controller may send the selected fuse curve and/or amp rating to the external device to allow a remote user to monitor the selection.

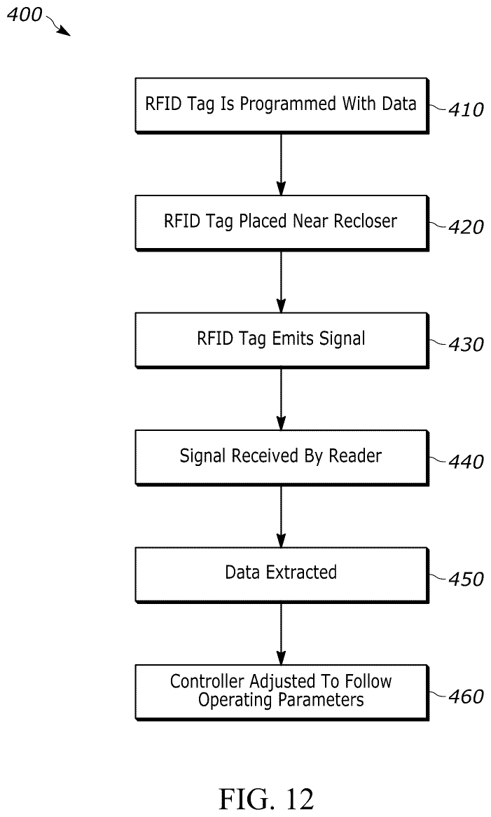

FIG. 12 shows an exemplary flow chart 400 for the controller 210 to select a fuse curve using an active RFID tag. In a first step, an RFID tag 410 is programmed with the required data 410. The RFID tag is then placed near the recloser 420. The RFID tag then emits a signal 430. The signal is received by the reader 440. The data is then extracted 450. The data can be extracted by the reader or by the controller. The controller can then access and follow the selected operating parameters 460. For example, the controller will follow the selected fuse curve and/or amp rating selected by a user. The controller can receive the operating parameter information or associated data from a local memory, or the information can be provided by the RFID tag in the emitted response.

While an exemplary implementation of the recloser is described in connection with a fuse cutout insulator and related components for a power distribution system, it will be readily apparent to one of ordinary skill in the art armed with the present specification that the components described herein can be applied to a multiplicity of fields and uses. In particular, the recloser can be used in connection with a power fuse or a sectionalizer. Likewise, the exemplary embodiments may be advantageous when coupling with a conductive blade to form an airbreak switch or used to hold other circuit make/break and sensing devices. The engagement interfaces can also be incorporated into other devices such as a fuse tube or other power distribution fuse components. Finally, one of ordinary skill in the art armed with the present specification will also understand that the present system may be easily modified to include different configurations, mechanisms, methods, and kits, which achieve some or all of the purposes of the present disclosure.

The foregoing detailed description has been provided for the purpose of explaining the general principles and practical application, thereby enabling others skilled in the art to understand the disclosure for various configurations and implementations, and with various modifications as are suited to the particular uses contemplated. This description is not necessarily intended to be exhaustive or to limit the disclosure to what is disclosed. Any of the configurations and/or elements disclosed herein may be combined with one another to form various additional embodiments not specifically disclosed. Accordingly, additional configurations and implementations are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings. The words “member,” “component,” “module,” “mechanism,” “element,” “device,” and the like are not a substitute for the word “means.” As such, no claim element should be construed as a means plus function unless the element is expressly recited using the phrase “means for.”

Functionality described herein may be implemented by any combination of hardware, software, or firmware. Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

Certain electrical components are generally shown and described in terms of their functions or end results as it would be understood by one of ordinary skill viewing this disclosure that the exact structure, connections, and components can be varied to achieve the desired results. In addition, certain implementation may include hardware, software, and electronic components or modules that, for purposes of discussion, may be illustrated and described as if most of the components were implemented solely in hardware. However, one of ordinary skill in the art, and based on a reading of this disclosure would recognize that in certain configurations the electronic-based aspects may be implemented in software (e.g., stored on non-transitory computer-readable medium) executable by one or more processing units, such as any combination of one or more of a general-purpose processor, microprocessor, DSP, FPGA, application specific integrated circuits (“ASICs”), and/or other programmable logic device. As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

What is claimed:

1. A recloser for a distribution system comprising:
a current sensor configured to measure an operating current of a distribution system;
a controller connected to the current sensor, the controller having at least one processor;
a circuit interrupter connected to the controller and configured to open a circuit to interrupt power in at least a portion of the distribution system; and
an RFID reader connected to the controller, the RFID reader configured to receive data from a user,
wherein the controller is configured to trigger the circuit interrupter to open the circuit in response to a detected fault current and wherein the fault current is determined based on a selected fuse curve.

2. The recloser of claim 1, wherein the RFID reader is configured to receive a signal from an RFID tag.

3. The recloser of claim 2, wherein the first RFID tag includes information relating to a fuse curve type.

4. The recloser of claim 2, wherein the second RFID tags include information relating to an amp rating.

5. The recloser of claim 2, wherein the RFID tag is a passive tag.

6. The recloser of claim 3, wherein the RFID tag is an active tag.

7. The recloser of claim 1, wherein the controller is configured to retrieve the selected fuse curve from local memory.

8. A distribution system fuse device comprising:
an insulator body having a weathershed;
a support bracket extending from the insulator body;
a hood connected to the insulator body, the hood having a hood contact;
a hinge member extending from the insulator body; and
a recloser pivotally connected to the insulator body by engagement of a pivot with the hinge member, the recloser having,
a current sensor configured to measure an operating current of a distribution system,
a controller connected to the current sensor, the controller having at least one processor,
a circuit interrupter connected to the controller and configured to open a circuit to interrupt power in at least a portion of the distribution system, and
an RFID reader connected to the controller, the RFID reader configured to receive data from a user,
wherein the controller is configured to trigger the circuit interrupter to open the circuit in response to a detected fault current and wherein the fault current is determined based on a selected fuse curve.

9. The distribution system fuse device of claim 8, wherein the RFID reader is configured to receive a signal from an RFID tag.

10. The distribution system fuse device of claim 9, wherein the RFID tag includes the selected fuse curve.

11. The distribution system fuse device of claim 8, wherein the controller retrieves the selected fuse curve from local memory.

12. The distribution system of claim 11, wherein the memory contains a plurality of fuse curves.

13. A method of setting the operating parameters of a controller for a distribution system fuse device comprising:
emitting a signal from a first RFID device, the signal containing fuse curve data;
receiving the emitted signal at a second RFID device;
extracting the fuse curve data; and
adjusting the operating parameters of a controller based on the fuse curve data.

14. The method of claim 13, wherein the first RFID device is an RFID tag and the second RFID device is a reader connected to the controller.

15. The method of claim 13, wherein the fuse curve data includes a curve type and an amp rating.

16. The method of claim 13, wherein the data is extracted by the controller.

17. The method of claim 16, wherein the data is extracted from local memory in the controller.

18. The method of claim 13, further comprising connecting the first RFID device to a hot stick and positioning the first RFID device in communication with the second RFID device.

19. The method of claim 13, further comprising programming the first RFID device to contain the fuse curve data.

20. The method of claim 13, further comprising connecting the first RFID device to a hot stick and positioning the first RFID device proximate the second RFID device.
